(19) United States
(12) Patent Application Publication
(10) Pub. No.: US 2006/0103694 A1
(43) Pub. Date: May 18, 2006

(54) CNT print head array

(75) Inventor: Khe C. Nguyen, Ho Chi Minh City (VN)

Correspondence Address: TRAN & ASSOCIATES, 6768 MEADOW VISTA CT., SAN JOSE, CA, 95135, US

(73) Assignee: Saigon Hi Tech Park, Ho Chi Minh City (VN)

(21) Appl. No.: 10/987,764

(22) Filed: Nov. 12, 2004

(51) Int. Cl. B41J 2/16

(52) U.S. Cl. 347/47

(57) ABSTRACT

Print head array technology composed of single or multiple carbon nano tubes formed on one substrate and actively controlled by electrical bias to reproduce nano scale patterning with high throughput production of integrated circuits. The CNT print head can perform as a thermo print head, an electron beam print head, an electrically controlled capillary print head or an electrochemical tip head.

### BACKGROUND

The present invention relates generally to lithographic equipment for manufacturing integrated circuit devices.

High-throughput lithography systems are important in the commercial fabrication of microelectronic components. They are used for high-volume production of small-area packages such as integrated circuits as well as large-area patterns such as flat-panel displays. Optical lithography is one of the most widely used technology for high-volume production because it can achieve high throughput via the parallel nature of its pattern generation, in which a large number of features are simultaneously printed onto a substrate during a single exposure. In conventional analog photolithography systems, the photographic equipment requires a mask for printing an image onto a subject. The subject may include, for example, a photo resist coated semiconductor substrate for manufacture of integrated circuits, metal substrate for etched lead frame manufacture, conductive plate for printed circuit board manufacture, or the like. A patterned mask or photo mask may include, for example, a plurality of lines or structures. During a photolithographic exposure, the subject is aligned to the mask accurately using mechanical controls with sophisticated alignment.

Conventional photolithography in wafer processing using a mask and a mask aligner requires an expensive mask making step and an expensive mask aligner. Moreover, contact exposure through the mask can destroy the photosensitive coating layer, depending on the materials used. Further, conventional photolithography may need expensive CEA (contrast enhancement agent) to enhance image contrast. Thus, avoiding the use of masks is desirable to improve the productivity and cost of microelectronic fabrication.

As noted in U.S. Pat. No. 6,238,852, the content of which is incorporated by reference, various projection imaging systems are used in fabrication of microelectronic modules. Single-field, or conventional, projection tools are those in which the image field of the lens is sufficient to accommodate the entire substrate. Typically, a projection lens with a 1:1 magnification is used. For different design resolutions, the maximum image field size of the projection lens is different: whereas a 1 mil resolution can be obtained over a 4 inch square field, the imageable area for 1 micron resolution must be limited to a field diameter no larger than 2-3 cm. Thus, conventional projection printing systems are limited by the fundamental trade-off between the desired resolution and the largest substrate they can image. In a step-and-repeat type of projection system, the total substrate area to be patterned is broken up into several segments, which segments are then imaged one at a time by stepping the substrate under the lens from one segment to the next. Due to the increased overhead time required for the stepping, settling and aligning steps for each segment, step-and-repeat projection systems deliver low throughputs.

A focused-beam direct-writing system uses a laser in a raster scanning fashion to expose all the pixels, one at a time, on the substrate. To be compatible with the spectral sensitivity of common photo resists, typically an argon-ion laser operating at one or more of its UV or blue wavelengths is employed. The laser beam is focused on the resist-coated substrate to the desired spot size. The focused spot is moved across the substrate in one dimension with a motor-driven scanning mirror. In conjunction, the stage holding the substrate is translated in the orthogonal dimension with a high-precision stepping motor. Simultaneously, the laser beam is modulated (typically, acousto-optically) to be either directed to the desired location on the substrate or deflected away. Thus, by driving the modulator and the two motors with appropriately processed pattern data, the entire substrate can be directly patterned. Of the many focused-beam direct-write systems currently available, the offered resolution varies from several microns for board patterning to under a micron for systems designed for mask-making applications for IC lithography. Since transfer of the pattern information by such tools takes place in a slow, bit-by-bit serial mode, typical substrate exposure times can range from 2 minutes to several hours per square foot, depending upon the resolution and the complexity of the pattern data. Although direct write systems do not require the use of masks—and are therefore not subject to many of the effects which limit mask-based technologies—the serial nature of their pattern generation renders direct-write systems significantly lower in throughput compared to contact, proximity, and projection printers.

Another technique known as holographic imaging systems utilize a mask which is a hologram of the pattern to be imaged, such that when “played back,” it projects the original pattern onto the substrate. The mask is generated by encoding the diffraction pattern from a standard mask in a volume hologram. Generally, for all but the simplest patterns, fabrication of the holographic mask requires numerous processing steps. In a holographic lithography system, the burden of imaging is placed entirely on the mask. Holographic imaging systems suffer from poor diffraction efficiency and are applicable, at best, for imaging of very periodic patterns of not very high resolution. If the pattern is not periodic, the imaging resolution degrades. Holographic masks are also considerably more expensive to generate, which is made further prohibitive when masks for many different layers are required for the substrate.

U.S. Pat. No. 5,691,541, which is hereby incorporated by reference, describes a digital, reticle-free photolithography system. The digital system employs a pulsed or strobe excimer laser to reflect light off a programmable digital mirror device (DMD) for projecting a component image (e.g., a metal line) onto a substrate. The substrate is mounted on a stage that is moves during the sequence of pulses. U.S. Pat. No. 6,379,867, hereby incorporated by reference, discloses another digital photolithography system which projects a moving digital pixel pattern onto specific sites of a subject. A “site” may represent a predefined area of the subject that is scanned by the photolithography system with a single pixel element. U.S. Pat. No. 6,473,237, hereby incorporated by reference, discloses a digital lithography system with a non-coherent light source for producing a first light and an optical diffraction element for individually focusing the first light into a plurality of second lights. The system also includes a pixel panel for generating a digital pattern, the pixel panel having a plurality of pixels corresponding to the plurality of second lights. A lens system may then direct the digital pattern to the subject, thereby enabling the lithography. Both digital photolithography systems project a pixel-mask pattern onto a subject such as a wafer, printed circuit board, or other medium. The systems provide a series of patterns to a pixel panel, such as a deformable mirror device or a liquid crystal display. The pixel panel provides images consisting of a plurality of pixel elements corresponding to the provided pattern that may be projected onto the subject. Each of the plurality of pixel elements is then simultaneously focused to different sites of the subject. The subject and pixel elements are then moved and the next image is provided responsive to the movement and responsive to the pixel-mask pattern. As a result, light can be projected onto or through the pixel panel to expose the plurality of pixel elements on the subject, and the pixel elements can be moved and altered, according to the pixel-mask pattern, to create contiguous images on the subject. However, the foregoing systems are expensive to operate. Moreover, improvements in image resolution are still needed.

In another trend, diazonapthoquinone (DNQ) is currently a main precursor for optical lithography is still the key component for the positive photo resists. The resist itself is a photo acid generator which can be washed away with alkaline developer. After development, the photo resist mask made out of DNQ and Novolac resin (positive photo resist) has been known to exhibits excellent etch resistance against conventional plasma such as SF6, CF4, O2 or base and acidic wet etching agents such as KOH, TMAH, HF, HCL, among others. The chemical resistance of DNQ/Novolac resin type photo resist mask also exhibits superior etch resistance over the known negative resists such as photoimageable polyimide, polymethylmethacrylate (PMMA), silicone based resist, styrene based resist, among others. In another word, DNQ/Novolack-type positive photo resist is still the best masking materials in terms of etch quality, cost issue and environmental safety.

Direct writing of photo resist ink using piezoelectric ink jet head onto a patterned surface has been known (for example, report by Kateri E. Paul et al, Appl Phys Lett 83(10) 2070(08 Sep. 2003) However, the technology is restricted to the low viscosity coating satisfying thin resist layer and not suitable for-high aspect ratio processing. The poor compatibility between the inking resist and printing process, the poor compatibility between the inking resist and substrate, the nozzle clogging due to resist chemistry instability, the limitation of feature size due to the nozzle size and printing speed. This technology has facing new challenges for large scale production. Direct writing process using laser, X-ray, electron beam, ion beam, molecular beam, dip- pen lithography have been known to produce sub micron and nano scale patterns as reviewed by G. M, Whitesides et al in Scientific American, September 2001, page 39. However, these techniques are slow due to the limitation of the current sensitivity of recording materials against writing head.

Carbon nano-tube has been described in a number of reports (for example, see S. Frank et al., Science 280, 1744 (1998) and T. T. Tsong, Phys. Rev. B 44, 13703 (1991)). Carbon nano tube has also been known as good electron source and has been utilized in scanning tunneling microscope (STM) tip (see Nobuyuki Aoki et al, Nano-Wirling Process using Carbon Nano-Tube by STM-Tip Induced Fabrication, 10th Foresight Conference on Molecular Nanotechnology).

There is increased demands of patterning having feature size in the nano scale. The conventional optical lithography is heading the limitation in short wavelength approaches in terms of both photoresist sensitivity and extreme UV exposure system as described by G. M, Whitesides et al appeared in Scientific American, September 2001, page 39.

### SUMMARY

Systems and methods are disclosed for printing micro and nano patterns using a carbon nano tube (CNT) print head. In one aspect, a carbon nano tube (CNT) print module includes one or more ink ejection nozzles formed using micro-electromechanical system (MEMS) processing, each nozzle including a CNT head and an interconnect wire coupled to each head to apply a voltage to the head.

Implementations of the module may include one or more of the following. The process is a nano-lithographic process as it is capable of producing patterns having feature size as small as 0.4 nm. The CNT print head array can be single or multiple carbon nano tubes formed on one substrate and actively controlled by electrical bias to reproduce nano scale patterning with high throughput production of integrated circuits. The CNT print head can perform as a thermo print head, an electron beam print head, an electrically controlled capillary print head or an electrochemical tip head.

The print head array can be manufactured using MEMS (Mechanical Electro Mechanical Systems) tooling to create interconnect in one side of the substrate, while it is connected to electrode array located in another side. The metal array which forms the electrode array is a catalyst for the plasma decomposition of hydrocarbon gas adsorbed thereon or single sheet graphite deposited thereon. In either case, catalytic metal patterns work as nucleation to grow carbon nano tubes. Besides the plasma-induced carbon nano tube forming process as above mentioned, heat-induced carbon nano tube forming from single sheet of graphite deposited on catalytic metal patterns can also be fabricated. The single sheet of graphite is chemically prepared by grafting the surface of hydrophobic carbon black particles with electrolytic functional groups. These chemical functional groups are able to split huge particles of carbon black into nano particles when being exposed to an electrolytic media including electric field and specific solvents. The above described specific graphite is named through the present invention as “liquid” nano carbon. The carbon particles exhibit particle sizes below 100 nm, 50 nm, or 20 nm from atomic force microscopic analysis. Particularly, specific electrolyticable solvents can breakdown the primary aggregate of carbon black into the nano particles having particle size less than 5 nm. When the particle size of “liquid” nano carbon comes down to certain limit, the heat can cause the cleavage of electrolytic groups attached to it to form carbon nano tube without metal catalyst.

Carbon nano tube can be grown from the liquid nano carbon. Thin films of liquid nano carbons can be formed on the surface of metal catalyst patterning by various process of solvent coating such as dip coating, spray coating, spin coating, blade coating, hopper coating, among others. The uniformity of film thickness can be easily achieved and that is the key to control the length of the tube. This process is more suitable for carbon nano tube print head array compared to plasma grown process.

Advantages of the CNT print head array may include one or more of the following. The system enables nano scale patterning reproduction. A high production throughput may be achieved when compared to single head imagers such as E beam, X-ray, ion beam, dip pen lithography, micro contact, and nano molding technique. A lower writing energy is needed relative to conventional X-ray lithography, E beam lithography, among others. The process is available for wide range of recording materials. The print head enables maskless lithography for large production runs. The process provides ideal and absolute contact exposure. Low cost photolithography is achieved without using masks. The system offers shorter processing time due to eliminating the mask making step. The production cost is reduced due to the simplification of the micro fabrication process. The maskless printing simplifies the photolithographic process and is more precise than the process with a mask aligner and stepper. The process is also economical, safe, and results in better lithography than conventional masking process. The process can replace or work in conjunction with contrast enhanced materials (CEM). Additionally, the system can maintain the best practice of DNQ/Novolack in a maskless lithography process manner so that the current parameters of photolithography still survive except making the masking process economical and simple.

### BRIEF DESCRIPTION OF THE DRAWINGS

FIG. 1A is a diagram of an exemplary print head array, and FIG. 1B is a diagram of an exemplary portion of the print head array of FIG. 1A.

FIG. 2 is an exemplary diagram of a process for making a carbon nano tube (CNT) print head array from a plasma CVD of hydrocarbon/hydrogen gas mixture.

FIG. 3A and 3B are exemplary diagrams showing a process of making a CNT print head array using “liquid” nano carbon.

FIG. 4 is an exemplary diagram describing an imaging process with a CNT print head on a thermo-hardening media.

FIG. 5 is an exemplary diagram of an imaging process using CNT print head in conjunction with color former and photoresist.

FIG. 6 is an exemplary diagram showing an “inking” process using CNT print head or print head array.

FIG. 7 is an exemplary diagram showing an imaging process using CNT print head array in conjunction with an immobilizing agent.

FIG. 8 shows an exemplary diagram of a CNT print head array as an electroplating head.

FIG. 9 is an exemplary flowchart describing printing operations using CNT print head array on semiconductor wafer.

FIGS. 10A-10C show various Scanning Electron Microscope (SEM) images of “liquid” nano carbon utilized to prepare a print head.

FIG. 11 is an Atomic Force Microscope (AFM) image of a liquid nano carbon utilized to prepare CNT print head.

### DESCRIPTION

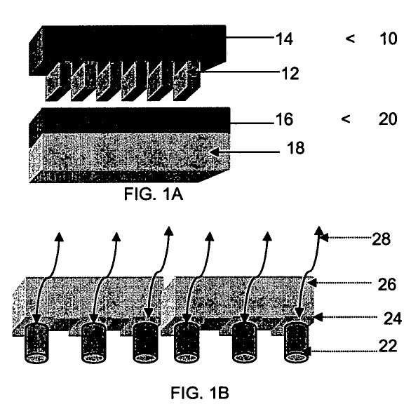

FIG. 1A shows an exemplary print head 10 for creating predetermined patterns on a material 20. The print head 10 includes a CNT print head array 12 positioned on a CNT print head support 14. The print head array 12 is positioned above the material 20 to form nano patterns thereon. In one embodiment, the material 20 includes one or more recording media 16 coated above an imaging substrate 18.

FIG. 1B shows in more detail the print head array 12. In the embodiment of FIG. I B, each CNT print head 22 is connected to an electrode 24. The three exemplary electrodes 24 are in turn mounted to a print head support portion 26. Each print head 22 is connected to an interconnect driver wire 28. Thus, in the embodiment of FIG. 1B, two print head supports 26 each support three print heads 22. The print heads 22 are in turn driven by six driver wires 28, each of which in turn is connected to a power supply to drive the head the driver wire 28 is connected to.

In one embodiment, under the application of an electric field, the CNT print head 22 emits electrons through an electron beam whose energy is strong enough to cause a chemical change or a physical change of predetermined material 20. The CNT print head 22 can be digitally controlled using a computer. In one implementation, the CNT print head 22 requires about 0.2-0.3 eV to achieve an intense and coherent beam, although other energy levels may be used.

The print head 22 operates with CNT in a single head or in multiple print head array 12, controlled by electrical bias. The CNT print head 22 can be a thermo print head, an electron source print head, or an electrically controlled capillary print head and an electrochemical tip head. An office printer or in an industrial printer can be adapted to deposit CNT on the material 20.

The CNT print head 22 can print an image on a flexible or an inflexible substrate 18 including but not limited to semiconductor wafer, oxide wafer, coated paper, plastics, metal, glass, plain paper. For high throughput production, a CNT print head array can be used. Due to low threshold energy of electron emission from the CNT print head 22, the CNT print head array 12 can be designed and fabricated to perform in parallel as a print head array with a low operating power than conventional electron beam lithography.

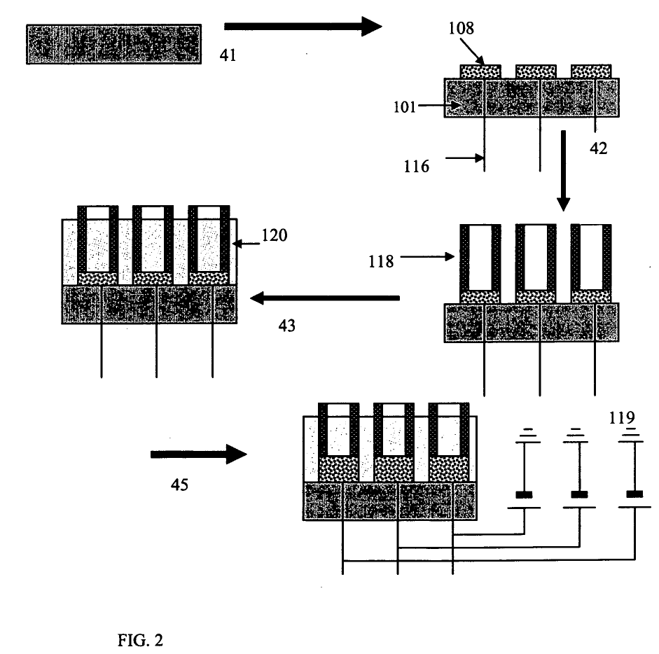

FIG. 2 is an exemplary diagram of a process for making a carbon nano tube (CNT) print head array from plasma CVD of hydrocarbon/hydrogen gas mixture. First, the process performs micro-patterns 108 of a metal catalyst on a substrate 101 and using MEMS (Micro-Electro Mechanical Systems) tooling, the process forms interconnects 116 on a back side of the substrate (step 41). Next, the process forms CNT print head(s) 1 18 on a metal catalyst using a plasma chemical vapor deposition (CVD) of a hydrocarbon gas (step 42). A protection layer 120 is formed for the CNT print head array (step 43). The print heads are then interconnected to their respective drivers 119 (step 45).

In one implementation, the CNT print head array can be made by patterning into an array matrix of the metal catalyst in one surface of the support substrate. Interconnects located at the other side of the support substrate are prepared and connected to the patterned metal catalyst array matrix to form electrodes. Then the CNT can grow on each individual metal catalyst pattern using a plasma CVD process of hydrocarbon gas mixed with hydrogen gas under low vacuum (10⁻¹-10⁻² Torr) condition and substrate temperature ranging between 600-800C. Next, the process deposits a passive layer to protect each head in the print head array. The individual print heads are connected to their respective power supply sources through the interconnect wires.

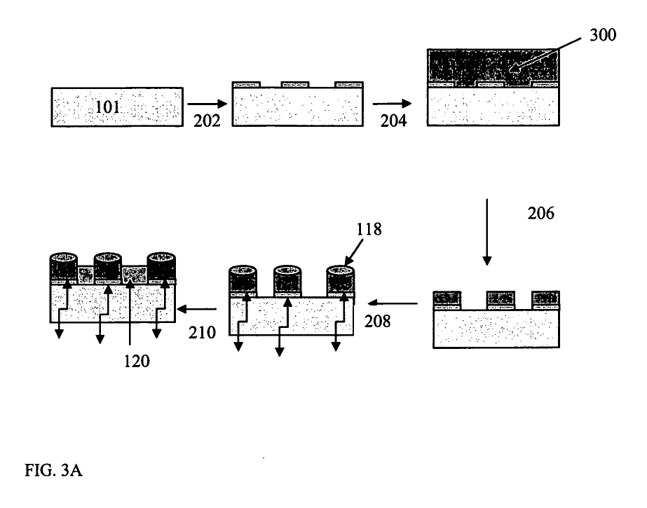

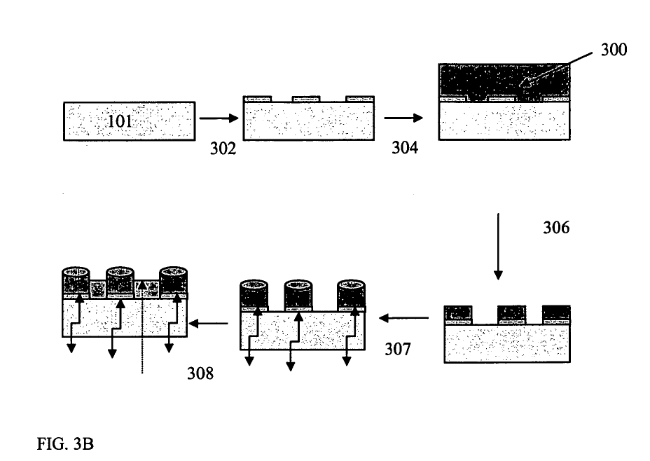

Another exemplary process of making a CNT print head array can be described in FIG. 3A. A support substrate 101 for the print head array can be a suitable wafer such as silicon wafer, SOI wafer, oxide wafer, other semiconductor wafer, flexible plastic substrate, hard board (inflexible) plastic substrate, ceramic substrate, and conductive metals and insulating substrates. With the substrate 101, the process micropatterns nano-catalysts on the substrate 101 (step 202). Next, the process spin-coats “liquid” nano carbon(300) elements on the micro-patterned catalysts (step 204). The liquid nano carbons are then micro-patterned above the catalyst (step 206). A hard bake is performed at 600C or more to form the CNT and interconnects are completed (step 208). A protection layer is deposited to form the CNT print head array (step 210). In one example, metal catalyst patterns are spin coated with a “liquid” nano carbon (300) to deposit a single sheet of graphite formed during the spin coating of the liquid nano carbon onto the patterned metal electrode array matrix using photolithography, and CNTs are grown on each single metal electrode catalyst center by heating of graphite single sheet under temperature ranging between 600C-1200° C. to form the CNT print head array.

Another exemplary process of making a CNT print head array is described in FIG. 3B. Again, starting with a substrate 101, the process micropatterns nano-catalysts on the substrate 101 (step 302). Next, the process spin-coats the catalyst micropatterns with a “liquid” nano carbon (step 304). Micropatterns of “liquid” nano carbon are formed above the nano-catalysts (step 306). A plasma bombardment (step 307) of a single sheet of graphite from the liquid nano-carbon is performed at a temperature of 600° C. or more forms the CNT and interconnects are then completed (step 308). A protection layer is deposited to protect the CNT print head array (step 310). In one example, the metal catalyst patterns are spin coated with liquid nano carbon to deposit a single sheet of graphite formed during the spin coating of liquid nano carbon onto the patterned metal electrode array matrix using photolithography, and CNTs are grown on each single metal electrode catalyst center by plasma bombardment of graphite single sheet under temperature ranging between 1000° C.-1200° C. to form the CNT print head array.

In one implementation, the processes of FIGS. 3A and 3B prepare wires or interconnects 116 from one side of the semiconductor substrate 101 using MEMS (Micro-Electro-Mechanical System) tooling (such as masking lithography, deep reactive ion etcher, among others). In one case, the substrate can be an SOI wafer. The interconnect 116 represents an input window from a suitable power supply to a print head. The interconnect 116 is linked with individual metal electrode patterns 24 formed on the other surface of the substrate by electron beam lithography, for example. The process then deposits a single sheet of graphite on a catalyst metal and patterns the metal to achieve patterns. The carbon nano tubes can be grown on the metal catalyst using PECVD (plasma enhanced CVD) of graphite under temperature ranging between 1000-1200° C. The process then grows a passivation layer such as Si₃N₄ by PECVD using lithography to protect the CNT. The passivation materials can be selected from various materials such as silicon compounds or polyimide. Next, the process connects tube print head with electronic circuitry including power sources or drivers 119.

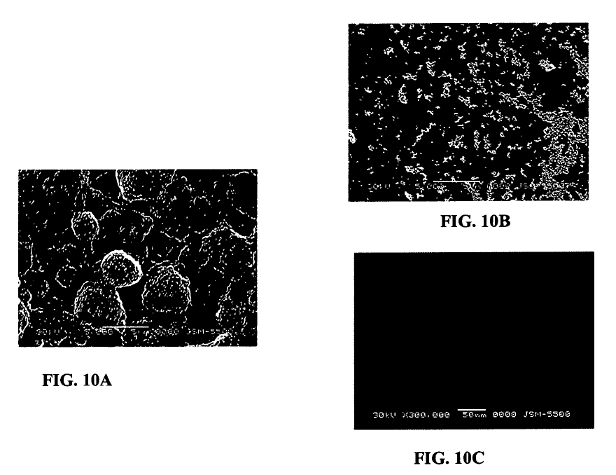

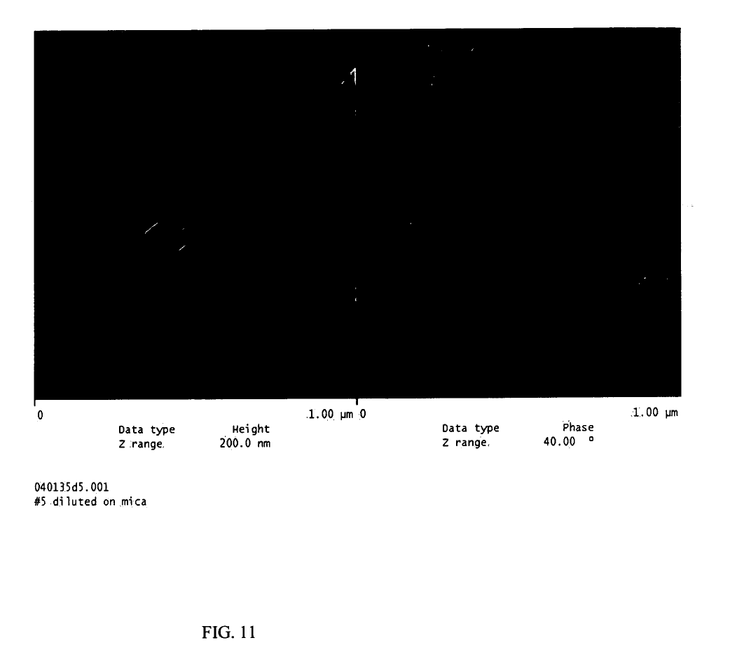

The liquid nano carbon can be obtained as follows. First, the process stirs and heats hydrophilic black colorant such as Cabojet 200 from Cabot Corp. until all water has evaporated with a dried product remaining. Next, the process disperses the dried product (about 1 g) into 80° C. heated distilled water (20 ml) containing 1.6 g sulfanilic acid to form dispersion A. Next, 0.8 g NaNO₂ is dissolved in 20 ml water to form dispersion B, which is then drop-wise added into dispersion A for 10 minutes and further stirred for approximately 30 minutes. The solution is then placed under approximately two hours of stirring under a temperature of about 80° C. until water is completely removed. The product is collected and purified to eliminate un-reacted raw materials with suitable solvents including reflux in Toluene, water, acetone, for example. The foregoing operations are repeated (for example 3-4 times) to achieve “liquid” nano particles. Examples of the liquid nano particles are shown in FIG. 10 using scanning electron microscopy (SEM). More details on the liquid nano carbon fabrication process is disclosed in commonly-owned co-pending application Ser. No. 10/843,411 filed on May 10, 2004 and entitled “MASKLESS LITHOGRAPHY USING UV ABSORBING NANO PARTICLE”, the content of which is hereby incorporated by reference.

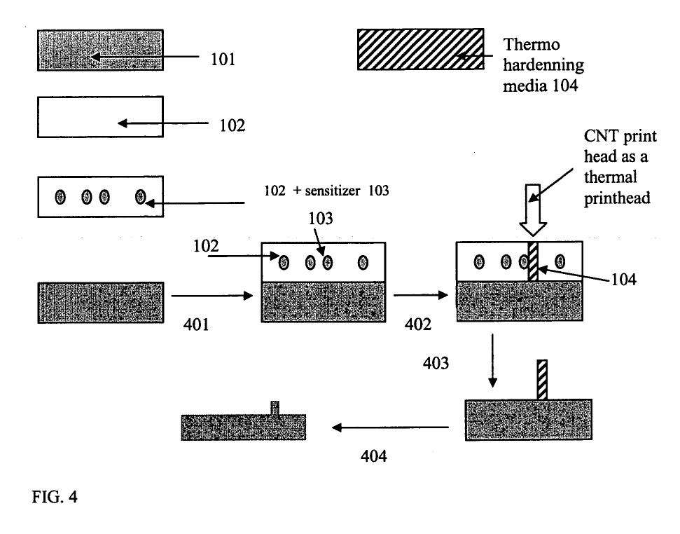

Turning now to FIG. 4, an exemplary diagram shows an imaging process where the CNT print head serves as a thermo print head or an electron beam print head. The print heads can write a predetermined pattern or image on a thermo-sensitive material. First, the imaging process spin-coats the substrate 101 with a thermosensitive material 102 and stabilizes the coating by evaporating the solvent using air drying or gentle heat drying (step 401). The thermosensitive material 102 may have a sensitizer 103 embedded in the material 102. The sensitizer can be carbon black or any materials which can enhance the heat energy absorbing efficiency. Next, the process writes on the thermosensitive layer 102 and sensitizer 103 with an energy beam from a CNT print head (step 402). An area 104 exposed to the CNT print head beam becomes hardened. Next, the image is developed using solvent which dissolves the thermosensitive layer 102 (step 403). This solvent can be water, for example. The exposed area 104 remains while the unexposed area is washed away. After washing, a thermo-hardening medium mask is formed above the substrate 101. The substrate 101 is then etched to yield a substrate with etched patterns when the thermo-hardening medium mask is removed (step 404).

The recording materials for the carbon nanotube print head serve as a thermo print head and electron beam print head are thermo-sensitive materials such as heat-induced solubility change media including thermo-cross-linking media, thermo-decomposed media, heat-induced hydrogen bonding former and hydrogen bonding deformer. The thermo-sensitive materials can also be a heat-induced color changer. Examples of heat-induced hydrogen bonding former and deformer include, but not limited to, polyamino acid derivatives, including protein products such as gelatine, collagene, egg albumin, among others. The heat energy-induced hydrogen forming process operates with various thermo-crosslinking media which can be found from groups of polymeric materials which can crosslink under heat or light such as (but not limited to) polycondensation products, crosslinkable polyesters, free radical generating acrylic compounds, crosslinkable siloxane polymers(products such as benzocyclobutane available from Dow Chemical), crosslinkable perfluoroalkyl polymers, fluoropolymers, crosslinkable hydroxylated polymers such as but not limited to phenolic resin (available from Monsanto Chemical), formaldehyde resin, poly vinyl aldehyde, polyvinyl acetal, polyvinyl butyral(available from Monsanto Chemical), polyvinyl alcohols, poly hydroxystyrene, hydroxylated polyesters, crosslinkable polyimide, polyethylene glycol, polypropylene glycol (available from Aldrich Chemicals), glyoxal, glutaraldehydes, among others. Besides thermocrosslinking polymers, heat-induced solubility change materials can include vinyl polymers and vinyl monomers such as methyl methacrylate, acrylic acid monomer, styrene, vinyl acetate, vinyl acetal, vinyl chloride, vinyl cinnamate, vinyl pyrridine, vinyl pyrrolidone, vinyl imidazole and the likes. The vinyl monomers are soluble and form film with sensitizer molecules. After being exposed to an energy source from the print head, the monomer(s) in the film turns into polymer. Or after being exposed to an energy source from the print head, the polymer(s) in the film turns into monomers and can be washed out such as PMMA under the effect of strong electron beam source or X-ray. All of these above mentioned polymers can be used alone, a polymer blend, or in a copolymer format.

In the above described masking lithography process using CNT print head, the thermo-hardening media can also be modified with photo/thermo-hardening materials. The photo-effect of light helps to complete the cross linking reaction besides thermal effect due to high energy beam. The UV absorbing nano particles can also absorb the high energy and perform energy transfer between particles and media molecules. One of the sensitizer which is cited here is “liquid” nano carbon. “Liquid” nano carbon is prepared using diazotization technique known to those skilled in the art such as the technique described in Advanced Organic Chemistry edited by Francis A. Carey and Richard J. Sundberg, page 714-772, published by Kluwer Academic/Academic Publishers, 4^{th} Edition, 2001. Through the diazotization reaction, any carbon products including graphite, coals, charcoals, carbon black or any carbon products from crude oils, tire, calcium carbide, unsaturated and saturated hydrocarbon compounds, among others, can be attached with desired functional groups to ease process of forming carbon particle having particle size in the nano scale range. The “solubility” of carbon particles in certain solvents is beneficial for the embedding of the particles into various kinds of media. In this case, the energy from carbon nano tube print head is effectively absorbed by the nano carbon particles and then transferred into the media which undergoes a physical or a chemical change. Thus the carbon particles act as thermo-sensitizer for the heat-induced crosslinking process. The combination of liquid nano carbon and thermo-crosslinking media can increase the writing speed up to 160 wafers of 9 inches diameter in one hour as only a few nanojoules required to form a single dot having feature size less than 10 um. After writing with the CNT print head, the image is developed with aqueous developer or solvent to render nano patterns on the recording media.

The thermosensitive materials can be deposited directly onto the target substrate or it can be deposited onto the photoresist layer already coated onto a substrate.

Using the above materials, the CNT print head can produce effectively feature size of nano scale below 10 nm on specific thermo-sensitive materials.

The recording medium for CNT print head can be deposited onto the etch target by any suitable spin coating, spray coating, dip coating, hopper coating, or roll coating process, among others. The thickness of the recording medium can be varied between 100 Å up to 100 μm after a soft bake process. The soft bake process removes the coating solvent and stabilizes the coating before pattern image writing with a CNT print head. The soft bake process can be an air dry process including natural air or wind air or turbulent air under ambient. The soft bake process can be a short bake on a hot plate set at temperature below 60° C. (less than 1 minute) or in an oven set at temperature below 100° C. (less than 10 minutes).

The substrate 101 can be glass, plastic, metal, or semiconductor material and can be rigid or flexible. Furthermore, the recording medium for the CNT print head can be deposited directly onto the substrate subjected to etching to form an etching mask for the substrate 101. Alternatively, the recording medium can be deposited onto the photoresist for performing etch mask. In order to prepare the photoresist masking, the photoresist layer carrying CNT recording mask receives a blanket exposure and the photoresist layer is then developed.

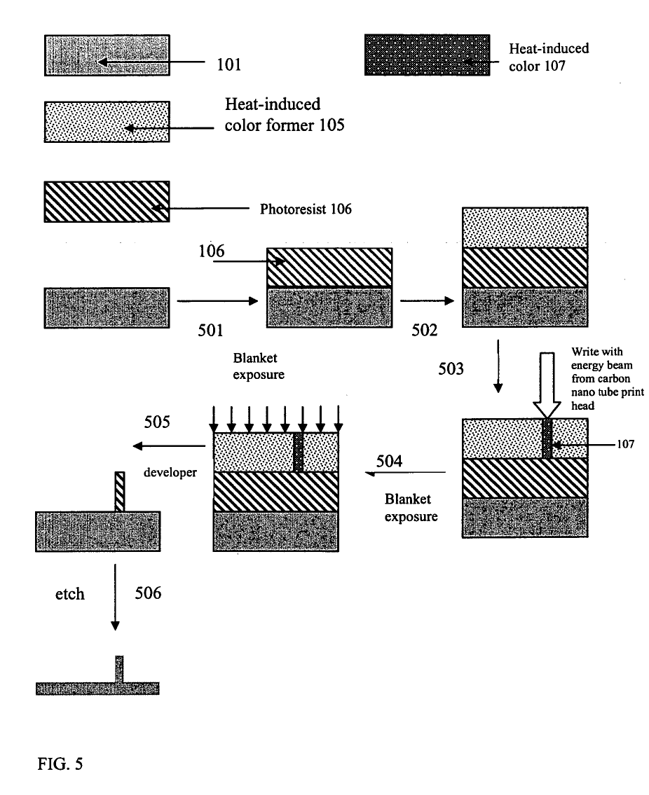

FIG. 5 describes an exemplary imaging process using a CNT print head in conjunction with a color former 105 and a photoresist 106. The etching process starts by spin-coating the substrate 101 with a positive photoresist layer 106 (step 501). A soft bake process is performed at a 11 0IC hot plate for 1 minute, and the substrate 101 is cooled down. Next, the process over-coats the resist layer 106 with a heat-induced color former layer 105 (step 502). The process stabilizes the coating by evaporating the solvent. The process then writes the image on the heat-induced color former layer 105 with an energy beam from the CNT print head (step 503). The written area undergoes color change and becomes heat-induced color section 107 and forms a mask for the photoresist layer 106. Next, the process blanket-exposes the entire system with light strongly absorbed by the resist (step 504). The image is then developed to obtain the photoresist mask for the substrate 101 (step 505). The substrate 101 is etched and the mask is removed after etching to achieve etch patterning on the substrate 101 (step 506). Heat-induced color formers such as leuco dyes, lactone compounds and other thermosensitive materials can be used in combination with a photoresist layer already coated directly onto the substrate as recording media for CNT print head as well.

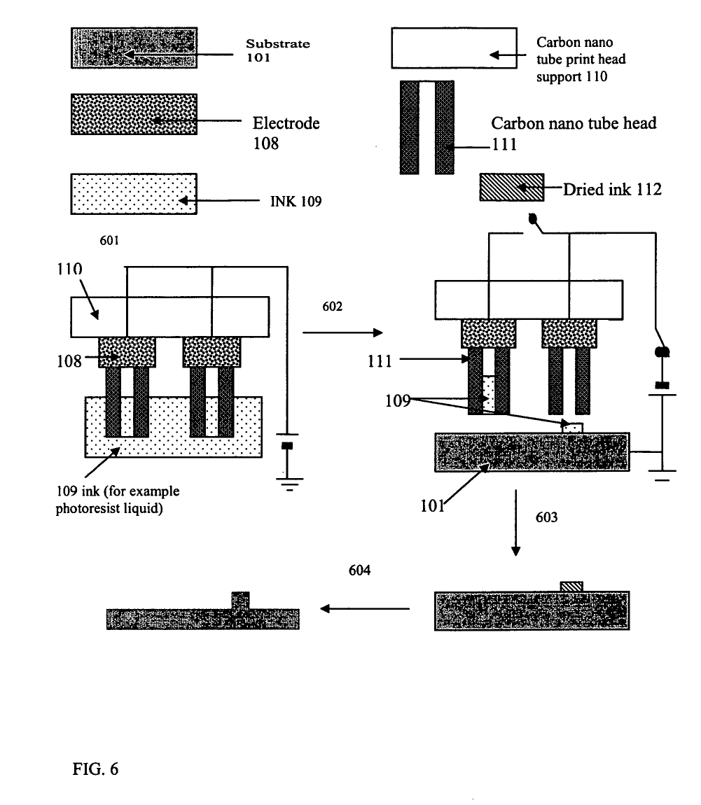

FIG. 6 describes an exemplary “inking” process using CNT print head or print head array. In this case, CNT print head serves as a pen which can electrically draws liquid into a tube and selectively delivers the drawn liquid onto the print media to form a nano size dot. The system performs a masking lithography process to achieve nano scale patterning reproduction using a CNT liquid jetting head. Under a pre-designed electrical bias voltage, the CNT liquid jetting head can suck or drawn a liquid and under electrical control the CNT print head can jet or squirt the liquid out when the CNT print head touches a surface with a predetermined fluid having a suitable viscosity. In this case, the CNT print head operates analogously to a drop-on-demand inkjet print head and provides a nano scale drop onto a drop receiving surface on the substrate 101. Specifically, the printed feature size on the receiving substrate can be less than 10 nm. The recording materials can be selected from a variety of substrate including but not limited to plain paper, coated paper, water soluble and oil soluble thermoplastics, thermoset plastics, metal, metal oxides, glass, cellulosic substrate, semiconductor substrate. The “ink” which can be electrically sucked and contained inside the CNT print head is in a liquid form or hot melt liquid having viscosity ranging between 0.01 cps and 100 cps. The liquid can be hydrophilic or hydrophobic. Inking materials for the carbon nanotube print head above described is fluid containing but not limited to small molecules such as UV absorbing molecules, metal oxides, graphite, inkjet inks, polymers, photoresist, organic LED materials, photo and/or thermo chromic molecules, thermosensitive or thermophotosensitive molecules (color change under heat, light with or without pressure) DNA, drug molecules, self-assembly molecules, metal and metal ions, electron donor molecules, electron acceptor molecules, immobilizing agents, dyes and pigments, phosphor, light emitting particles or components.

FIG. 6 describes an exemplary “inking” process using CNT print head or print head array. A CNT head 111 is attached to an electrode 108, which in turn is attached to a CNT print head support 110. Each electrode is connected through suitable switches to a power source. The switches can be mechanical switches or can be electrical switches such as transistors, for example. First, the process wets a CNT print head with a liquid ink (step 601). Next, the image is printed on a print substrate with the liquid ink (step 602). This process fills the CNT heads 111 with “inking” fluid 108 by providing a positive voltage to the electrodes 108. By reversing the polarity of the voltage to one of the CNT print head, the process jets the filled fluid onto a target area of the substrate 101. The ink 108 is dried into dried ink 112, which acts as a mask. The substrate is then etched with the dried ink mask 112 (step 603). The process then removes the mask 112 at the etch process to achieve a substrate 101 with etched patterns (step 604) to arrive at the formed substrate.

The immobilizing agents are chemical species which can form a complex with another chemical species yielding insolubility. For example, polyethylene imine is an effective immobilizing agent for strong acidic components. Another example of an effective immobilizing agent is cations which can form bulky complex with anions and render insolubility. In other words, the immobilizing agent is an insoluble complex former.

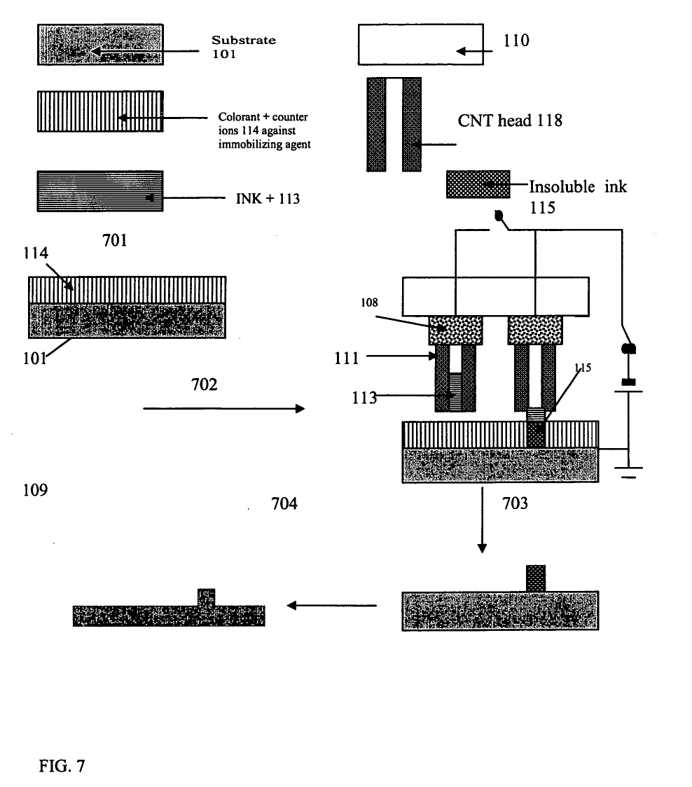

FIG. 7 describes the imaging process using CNT print head array in conjunction with an immobilizing agent 113. This process spin-coats substrate 101 with counter-ions 114 and stabilizes the layer by removing solvent (step 701). Through appropriate switch settings, a positive voltage is applied to the electrode 108 to pick up the ink 113. Next, after the print head is appropriately positioned above the substrate 101, through proper switch settings, a negative voltage is applied to a predetermined CNT print head to release the ink from the print head onto the insoluable ink 115 above the substrate 101 (step 702). Thus, the process places ink on counter-ions 114 with a fluid containing an immobilizing agent 113 to form an insoluble pattern 115. The insoluble pattern 115 is developed using water to form a mask (step 703). The process then etches the substrate 101 and removes the mask to obtain an etched substrate (step 704). The substrate 101 can be glass, plastics, metal, semiconductor, plain paper, coated paper, and the substrate 101 can also be rigid or flexible as discussed above.

FIG. 8 describes the CNT print head array as an electroplating head. In this case, the print head array is applied to the surface of a target substrate carrying electrode 108 and immersed into electrolyte (NiCl₂) dissolved in water. Only biased print heads can deposit Ni metal onto the substrate. Unbiased print heads can hold, but not deposit materials on the substrate. The CNT print head can perform electroplating for any metals including but not limited to Au, Cu, Ag, Pt, Pd, Cr, among others.

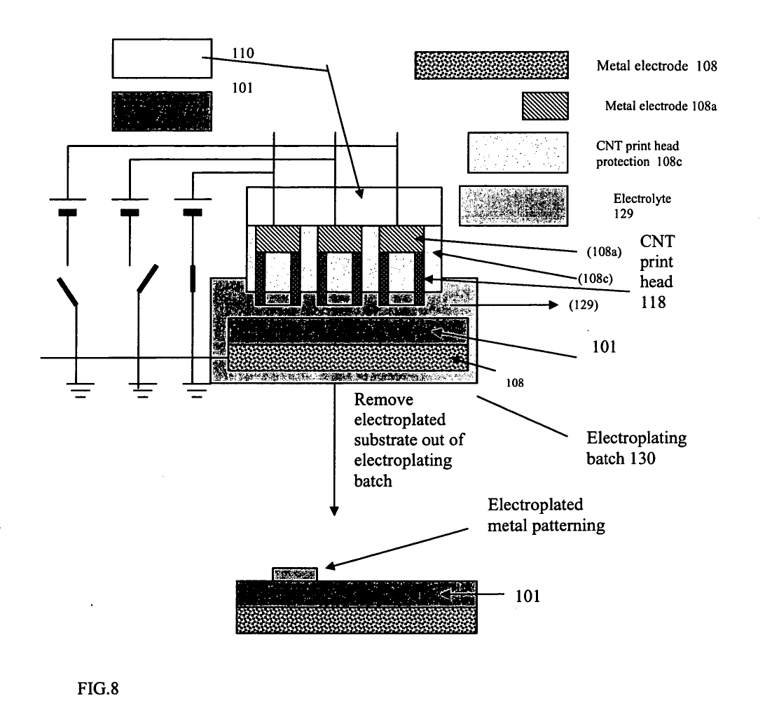

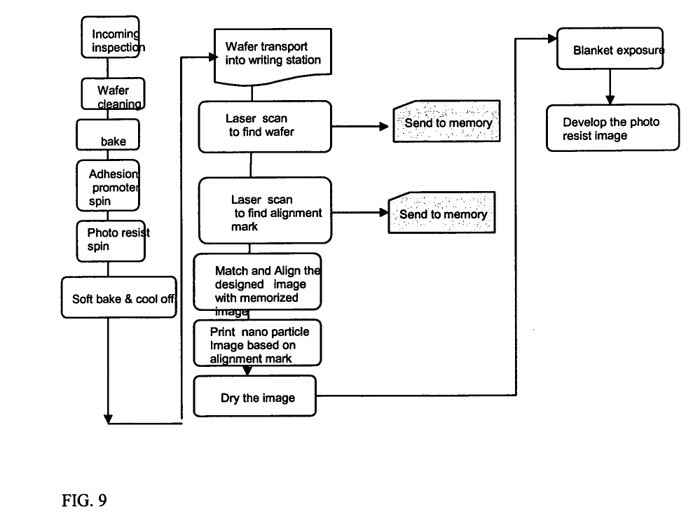

An exemplary imaging process on a semiconductor wafer with previous history for circuit design having multi layer structure using CNT print head array is depicted in FIG. 9. In general, the equipment for maskless lithography can include a digital camera or other imaging equipment that scans a wafer to find and memorize the position of alignment marks. Next, a computer with suitable software matches a mask design image onto the wafer. Next, a designed image is printed on the wafer. The digital printing can be done by inkjet(piezo, thermal) print head, thermal print head, laser print head, nano-imprint transfer process, e beam, X-ray, and gamma rays, among others.

Turning now to FIG. 9, the wafer is initially inspected in an incoming inspection operation. Next, the wafer is cleaned. The wafer is then baked. An adhesion promoter is spin-coated on the wafer. Next, a photo-resist layer is spin-coated on the wafer. The combination is soft-baked and allowed to cool.

The processed wafer is then transported into a writing station or chamber. A scan is performed to determine the wafer position. The scan can be performed by a laser scanner, among others. A computer receives the scan and finds one or more alignment marks on the wafer. The computer matches and aligns a designed image with the scanned image of the wafer. Once the designed image is aligned with the wafer, the print process begins. A print head prints the designed image with nano particles based on the aligned mark. The image is then dried. A blanket exposure operation is performed as discussed above, and the photo-resist image is then developed.

FIGS. 10A-10C show various Scanning Electron Microscope (SEM) images of “liquid” nano carbon utilized to prepare a print head, while FIG. 11 is an Atomic Force Microscope (AFM) image of a liquid nano carbon utilized to prepare CNT print head. FIG. 10A shows the original raw carbon material at a 5000× magnification. FIG. 10B shows exemplary liquid nano carbon elements that are electrolytically separated by water at a 5000× magnification. FIG. 10C shows liquid nano carbon elements that have been electrolytically separated by water and base at a magnification of 300,000×. FIG. 11 shows an Atomic Force Microscopy image of liquid nano carbon having individual particle size of less than 30 nm.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (Asics) or suitably programmed field programmable gate arrays (FPGAs).

From the a foregoing disclosure and certain variations and modifications already disclosed therein for purposes of illustration, it will be evident to one skilled in the relevant art that the present invention can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A carbon nano tube (CNT) print module, comprising:
one or more ink ejection nozzles formed using micro-electromechanical system (MEMS) processing, each nozzle including a CNT head and an interconnect wire coupled to each head to provide a voltage to each head.

2. The CNT print module of claim 1, wherein each ink ejecting nozzle comprises one of: a thermo print head, an electron source print head, an electrically controlled capillary print head and an electrochemical tip head.

3. The CNT print module of claim 1, wherein the one or more ink ejection nozzles print an image on one of: a flexible substrate and an inflexible substrate.

4. The CNT print module of claim 3, wherein the substrate comprises one of: a semiconductor wafer, an oxide wafer, a plastic wafer, a metal wafer, a glass wafer, and a paper wafer.

5. The CNT print module of claim 1, wherein the nozzles are made from a process comprising:
patterning a metal catalyst array on a first surface of a support substrate;
forming interconnects located on a second surface of the support substrate and coupling the interconnects to the patterned metal catalyst array to form an electrode array matrix;
depositing liquid nano carbon onto the electrode array matrix using photolithography;
growing carbon nano tubes on the electrode array matrix by plasma CVD bombardment or by heating the liquid nano carbon to form a CNT print head array;
depositing a passive layer to protect the CNT print head array; and
coupling the print head array to a driver array with the interconnects.

6. The CNT print module of claim 1, wherein the nozzles are made from a process comprising:
patterning a metal catalyst array on a first surface of a support substrate;
forming interconnects located on a second surface of the support substrate and coupling the interconnects to the patterned metal catalyst array to form an electrode array matrix;
depositing liquid nano carbon onto the electrode array matrix using photolithography;
growing carbon nano tubes on the electrode array matrix by plasma CVD of a hydrocarbon or a hydrogen gas mixture under a temperature between 800-900° C. to form a CNT print head array.
depositing a passive layer to protect the CNT print head array; and
coupling the print head array to a driver array with the interconnects.

7. The CNT print module of claim 6, comprising preparing a liquid nano carbon by multiple diazotization of carbon products including carbon black, and fallerene.

8. The CNT print module of claim 7, wherein the liquid nano carbon comprises carbon particles each having a particle size smaller than 30 nm.

9. The CNT print module of claim 1, comprising a support substrate comprising one of: a silicon wafer, an SOI wafer, an oxide wafer and a semiconductor wafer.

10. The CNT print module of claim 1, comprising a recording material made from a thermosensitive material.

11. The CNT print module of claim 10, wherein the thermosensitive material comprises a heat-induced solubility change medium.

12. The CNT print module of claim 10, wherein the thermosensitive material comprises one of: a thermo-decomposed medium, a heat-induced color former and heat-induced hydrogen bonding former, and a thermocrosslinking medium.

13. The CNT print module of claim 12, wherein the heat-induced hydrogen bonding former comprises a polyamino acid derivative.

14. The CNT print module of claim 12, wherein the heat-induced hydrogen bonding former comprises one of: egg albumin and protein product.

15. The CNT print module of claim 12, wherein the heat-induced hydrogen bonding former comprises a heat-induced crosslinking binder containing a carbon particle having a particle size below 100nm.

16. The CNT print module of claim 10, wherein the thermosensitive materials are deposited directly onto a target substrate.

17. The CNT print module of claim 10, wherein the thermosensitive materials are deposited onto the photoresist layer coated above a substrate.

18. The CNT print module of claim 1, comprising a recording material having a fluid containing one of: UV absorbing molecules, metal oxides, liquid nano carbon, UV absorbing nano particles, inkjet inks, polymers, photoresist, organic LED materials, photochromic molecules, thermochromic molecules, DNA, self-assembly molecules, metal and metal ions, electron donor molecules, electron acceptor molecules, immobilizing agents, dyes and pigments, and oils.

19. A process for forming carbon nano tube (CNT) print module, comprising:
applying micro-electromechanical system (MEMS) processing to form one or more ink ejection nozzles, each nozzle including a CNT head; and
coupling an interconnect wire to each head to provide a voltage to the head.
